(19) United States
(12) Patent Application Publication
(10) Pub. No.: US 2026/0172225 A1
(43) Pub. Date: Jun. 18, 2026

(54) BANDWIDTH EFFICIENT HASH CODE GENERATION

(71) Applicant: Fujitsu Limited, Kawasaki-shi (JP)

(72) Inventor: Shahriar EMAMI, San Jose, CA (US)

(73) Assignee: Fujitsu Limited, Kawasaki-shi (JP)

(21) Appl. No.: 18/981,248

(22) Filed: Dec. 13, 2024

(51) Int. Cl. H04L 9/06; H04L 9/40

(52) U.S. Cl. CPC H04L 9/065; H04L 9/0643; H04L 63/0457

(57) ABSTRACT

In an embodiment, a set of hash functions and a set of data streams to be hashed may be received. Each of a first hash function and a second hash function may be selected from the received set of hash functions by using a hash selector in an encoder system. The first hash function is applied on a first set of data streams to generate a first hashed data stream. The second hash function is applied on a second set of data streams to generate a second hashed data stream. An encoded data stream associated with the set of data streams is generated. The generated encoded data stream is transmitted to a decoder system associated with the encoder system, wherein the decoder system is configured to determine the set of data streams from the transmitted encoded data streams, based on both the first hash function and the second hash function.

### FIELD

The embodiments discussed in the present disclosure are related to bandwidth efficient hash code generation.

### BACKGROUND

Advancements in the field of networking and telecommunications have led to development of bandwidth efficient and secure network systems such as, an open radio access network (O-RAN). Such systems may include a plurality of interconnected blocks. Information from one block may be sent to another block based on the interconnection. In order to maintain an integrity of the information, a block transmitting the information may hash the information prior to transmission of the information. Typically, for a given number of data sets, a bandwidth of cumulative hashes may be fixed. Such fixed bandwidth may be unaffordable. That is, in order to avoid congestion and for effective transmission, the bandwidth of cumulative hashes may need to be minimized.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include a set of operations, which may include receiving a set of hash functions and a set of data streams to be hashed. The set of operations may further include selecting, by using a hash selector in the encoder system, each of a first hash function and a second hash function, from the received set of hash functions. The set of operations may further include applying the selected first hash function on a first set of data streams from the received set of data streams. The set of operations may further include generating a first hashed data stream based on the application of the selected first hash function on the first set of data streams. The set of operations may further include applying the selected second hash function on a second set of data streams from the received set of data streams. The set of operations may further include generating a second hashed data stream based on the application of the selected second hash function on the second set of data streams. The set of operations may further include generating an encoded data stream associated with the set of data streams, based on the generated first hashed data stream and the generated second hashed data stream. The set of operations may further include transmitting the generated encoded data stream to a decoder system associated with the encoder system, wherein the decoder system may be configured to determine the set of data streams from the transmitted encoded data streams, based on each of the first hash function and the second hash function.

According to another aspect of an embodiment, a method may include a set of operations, which may include receiving an encoded data stream from an encoder system associated with the decoder system, wherein the received encoded data stream includes a first hashed data stream and a second hashed data stream. The set of operations may further include selecting, by using a hash de-selector in the decoder system, each of a first hash function and a second hash function, from a set of hash functions. The set of operations may further include applying the selected first hash function on the received encoded data streams. The set of operations may further include generating a first hash output based on the application of the selected first hash function on the received encoded data streams. The set of operations may further include executing a first comparison, by using a comparator in the decoder system, between the generated first hash output and the first hashed data stream. The set of operations may further include applying the selected second hash function on the received encoded data streams. The set of operations may further include generating a second hash output based on the application of the selected second hash function on the received encoded data streams. The set of operations may further include executing a second comparison, by using the comparator, between the generated second hash output and the second hashed data stream. The set of operations may further include generating, by using a decoding logic in the decoder system, a set of data streams, based on the executed first comparison and the executed second comparison. The set of operations may further include rendering information associated with the generated set of data streams.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example environment related to a bandwidth efficient hash code generation;

FIG. 2 is a block diagram that illustrates an exemplary electronic device for the bandwidth efficient hash code generation;

FIG. 3 is a diagram that illustrates an execution pipeline for bandwidth efficient hash code generation;

FIG. 4 is a diagram that illustrates an execution pipeline for generation of a set of data streams;

FIG. 5A is a diagram that illustrates an exemplary scenario for bandwidth efficient hash code generation;

FIG. 5B is a diagram that illustrates an exemplary scenario for generation of the set of data streams;

FIG. 6 is a diagram that illustrates a flowchart of an example method for bandwidth efficient hash code generation; and

FIG. 7 is a diagram that illustrates a flowchart of an example method for generation of the set of data streams;

all according to at least one embodiment described in the present disclosure.

### DESCRIPTION OF EMBODIMENTS

Some embodiments described in the present disclosure relate to methods and systems for bandwidth efficient hash code generation. In the present disclosure, a set of hash functions and a set of data streams to be hashed may be received. Each of a first hash function and a second hash function may be selected from the received set of hash functions by using a hash selector in an encoder system. The selected first hash function may be applied on a first set of data streams from the received set of data streams. A first hashed data stream may be generated based on the application of the selected first hash function on the first set of data streams. The selected second hash function may be applied on a second set of data streams from the received set of data streams. A second hashed data stream may be generated based on the application of the selected second hash function on the second set of data streams. An encoded data stream associated with the set of data streams may be generated based on the generated first hashed data stream and the generated second hashed data stream. The generated encoded data stream may be transmitted to a decoder system associated with the encoder system, wherein the decoder system may be configured to determine the set of data streams from the transmitted encoded data streams, based on each of the first hash function and the second hash function.

According to one or more embodiments of the present disclosure, the technological field of hash code generation may be improved by configuring a computing system in a manner that the computing system may be able to generate a bandwidth efficient encoded data stream. The computing system may receive a set of hash functions and a set of data streams to be hashed. The computing system may select, by using a hash selector in the encoder system, each of a first hash function and a second hash function, from the received set of hash functions. The computing system may apply the selected first hash function on a first set of data streams from the received set of data streams. The computing system may generate a first hashed data stream based on the application of the selected first hash function on the first set of data streams. The computing system may apply the selected second hash function on a second set of data streams from the received set of data streams. The computing system may generate a second hashed data stream based on the application of the selected second hash function on the second set of data streams. The computing system may generate an encoded data stream associated with the set of data streams, based on the generated first hashed data stream and the generated second hashed data stream. The computing system may transmit the generated encoded data stream to a decoder system associated with the encoder system, wherein the decoder system may be configured to determine the set of data streams from the transmitted encoded data streams, based on each of the first hash function and the second hash function.

It may be appreciated that network systems such as, an open radio access network (O-RAN), may include a plurality of interconnected blocks. Information from one block may be sent to another block based on the interconnection. In order to maintain an integrity of the information, the block transmitting the information may hash information prior to transmission of the information. Typically, for a given number of data sets, a bandwidth of cumulative hashes may be fixed. Such fixed bandwidth may be unaffordable. That is, in order to avoid congestion and for effective transmission, the bandwidth of cumulative hashes may need to be minimized.

The present disclosure may provide a method that facilitates bandwidth efficient hash code generation. For such bandwidth efficient hash code generation, an electronic device of the present disclosure may employ a method that may generate the first hashed data stream based on the application of the selected first hash function on the first set of data streams. The method may generate the second hashed data stream based on the application of the selected second hash function on the second set of data streams. The method may generate the encoded data stream associated with the set of data streams, based on the generated first hashed data stream and the generated second hashed data stream. The method may transmit the generated encoded data stream to the decoder system associated with the encoder system. A bandwidth needed for transmitting the encoded data stream may be lesser than a bandwidth needed for transmitting a hashed stream of each of the set of data streams individually. Thus, an application of the disclosed method during transmission of hashed data may prevent occurrence of a denial of service (DoS) condition. Further, the disclosed method may be used in application areas where bandwidth efficient transfer of information may be sought. For example, the disclosed method may be used in O-RAN, hash-based message authentication code (HMAC), digital signatures, and the like.

Embodiments of the present disclosure are explained with reference to the accompanying drawings.

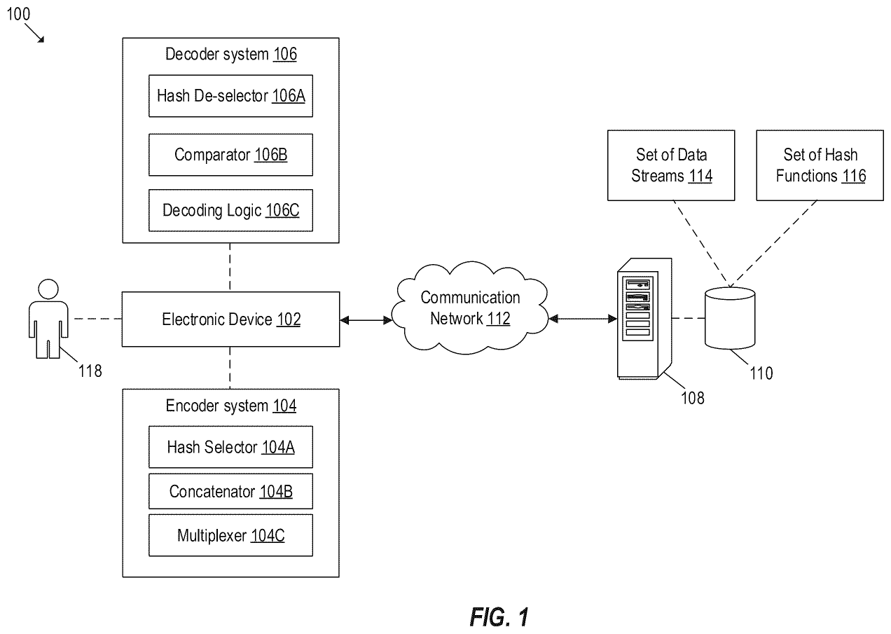

FIG. 1 is a diagram representing an example environment related to a bandwidth efficient hash code generation, according to at least one embodiment described in the present disclosure. With reference to FIG. 1, there is shown an environment 100. The environment 100 may include an electronic device 102, an encoder system 104, a decoder system 106, a server 108, a database 110, and a communication network 112. The electronic device 102 and the server 108 may be communicatively coupled to one another, via the communication network 112. The encoder system 104 may include a hash selector 104A, a concatenator 104B, and a multiplexer 104C. The decoder system 106 may include a hash de-selector 106A, a comparator 106B, and a decoding logic 106C. The database 110 may include a set of data streams 114 and a set of hash functions 116. In FIG. 1, there is further shown a user 118, who may be associated with or operate the electronic device 102.

Although a single electronic device (i.e., the electronic device 102) is shown in FIG. 1, the scope of the disclosure is not so limited. The environment 100 may include multiple such electronic devices (including the encoder system 104 and/or the decoder system 106) interconnected through the communication network 112.

The electronic device 102 may include suitable logic, circuitry, and interfaces that may be configured to perform bandwidth efficient hash code generation. The electronic device 102 may be further configured to receive the set of hash functions 116 and the set of data streams 114 to be hashed. The electronic device 102 may be further configured to select, by using the hash selector 104A in the encoder system 104, each of a first hash function and a second hash function, from the received set of hash functions 116. The electronic device 102 may be further configured to apply the selected first hash function on a first set of data streams from the received set of data streams 114. The electronic device 102 may be further configured to generate a first hashed data stream based on the application of the selected first hash function on the first set of data streams. The electronic device 102 may be further configured to apply the selected second hash function on a second set of data streams from the received set of data streams 114. The electronic device 102 may be further configured to generate a second hashed data stream based on the application of the selected second hash function on the second set of data streams. The electronic device 102 may be further configured to generate an encoded data stream associated with the set of data streams 114, based on the generated first hashed data stream and the generated second hashed data stream. The electronic device 102 may be further configured to transmit the generated encoded data stream to the decoder system 106 associated with the encoder system 104, wherein the decoder system 106 may be configured to determine the set of data streams 114 from the transmitted encoded data streams, based on each of the first hash function and the second hash function.

Examples of the electronic device 102 may include, but are not limited to, a computing device, a smartphone, a cellular phone, a mobile phone, a gaming device, a mainframe machine, a server, a computer workstation, any network-connected device with memory and processing resources, an encoder/decoder device, and/or a consumer electronic (CE) device.

The encoder system 104 may include suitable logic, circuitry, and interfaces that may be configured to perform bandwidth efficient hash code generation. The encoder system 104 may be configured to receive the set of hash functions 116 and the set of data streams 114 to be hashed. The encoder system 104 may be further configured to select, by using the hash selector 104A in the encoder system 104, each of the first hash function and the second hash function, from the received set of hash functions 116. The encoder system 104 may be further configured to apply the selected first hash function on the first set of data streams from the received set of data streams 114. The encoder system 104 may be further configured to generate the first hashed data stream based on the application of the selected first hash function on the first set of data streams. The encoder system 104 may be further configured to apply the selected second hash function on the second set of data streams from the received set of data streams 114. The encoder system 104 may be further configured to generate the second hashed data stream based on the application of the selected second hash function on the second set of data streams. The encoder system 104 may be further configured to generate the encoded data stream associated with the set of data streams 114, based on the generated first hashed data stream and the generated second hashed data stream. The encoder system 104 may be further configured to transmit the generated encoded data stream to the decoder system 106 associated with the encoder system 104, wherein the decoder system 106 may be configured to determine the set of data streams 114 from the transmitted encoded data streams, based on each of the first hash function and the second hash function.

Examples of the encoder system 104 may include, but are not limited to, a computing device, a smartphone, a cellular phone, a mobile phone, a gaming device, a mainframe machine, a server, a computer workstation, any network-connected device with memory and processing resources, and/or a consumer electronic (CE) device.

The hash selector 104A may include suitable logic, circuitry, and interfaces that may be configured to select each of the first hash function and the second hash function, from the received set of hash functions 116. The hash selector 104A may be included in the encoder system 104.

The concatenator 104B may include suitable logic, circuitry, and interfaces that may be configured to concatenate, a first plurality of data streams from the received set of data streams 114, wherein the first set of data streams may be generated based on the concatenation of the first plurality of data streams. Further, the concatenator 104B may be configured to concatenate a second plurality of data streams from the received set of data streams 114, wherein the second set of data streams may be generated based on the concatenation of the second plurality of data streams. The concatenator 104B may be included in the encoder system 104.

The multiplexer 104C may include suitable logic, circuitry, and interfaces that may be configured to multiplex the first hashed data stream and the second hashed data stream, wherein the generation of the encoded data stream may be further based on the multiplexing of the first hashed data stream and the second hashed data stream. The multiplexer 104C may be included in the encoder system 104.

The decoder system 106 may include suitable logic, circuitry, and interfaces that may be configured to generate the set of data streams 114. The decoder system 106 may receive an encoded data stream from the encoder system 104 associated with the decoder system 106, wherein the received encoded data stream includes a first hashed data stream and a second hashed data stream. The decoder system 106 may select, by using the hash de-selector 106A in the decoder system 106, each of a first hash function and a second hash function, from a set of hash functions. The decoder system 106 may apply the selected first hash function on the received encoded data streams. The decoder system 106 may generate a first hash output based on the application of the selected first hash function on the received encoded data streams. The decoder system 106 may execute a first comparison, by using the comparator 106B in the decoder system 106, between the generated first hash output and the first hashed data stream. The decoder system 106 may apply the selected second hash function on the received encoded data streams. The decoder system 106 may generate a second hash output based on the application of the selected second hash function on the received encoded data streams. The decoder system 106 may execute a second comparison, by using the comparator 106B, between the generated second hash output and the second hashed data stream. The decoder system 106 may generate, by using a decoding logic (e.g., the decoding logic 106C) in the decoder system 106, the set of data streams 114, based on the executed first comparison and the executed second comparison. The decoder system 106 may rendering information associated with the generated set of data streams 114.

Examples of the decoder system 106 may include, but are not limited to, a computing device, a smartphone, a cellular phone, a mobile phone, a gaming device, a mainframe machine, a server, a computer workstation, any network-connected device with memory and processing resources, and/or a consumer electronic (CE) device.

The hash de-selector 106A may include suitable logic, circuitry, and interfaces that may be configured to select each of the first hash function and the second hash function, from the set of hash functions 116. The hash de-selector 106A may be included in the decoder system 106.

The comparator 106B may include suitable logic, circuitry, and interfaces that may be configured to execute a first comparison between the generated first hash output and the first hashed data stream. The comparator 106B may execute the second comparison between the generated second hash output and the second hashed data stream. The comparator 106B may also be included in the decoder system 106.

The decoding logic 106C may include suitable logic, circuitry, and interfaces that may be configured to concatenate a result of the executed first comparison and a result of the executed second comparison to generate the set of data streams (for example, the set of data streams 114). The decoding logic 106C may be included in the decoder system 106.

A person having ordinary skill in the art will understand that the electronic device 102 may include at least one of the encoder system 104 or the decoder system 106. In one scenario, two communicating electronic devices may include both the encoder system 104 and the decoder system 106. For a certain data stream at a certain time, one of the two electronic devices may function as the encoder system 104 and the other of the two electronic devices may function as the decoder system 106, such that the first electronic device encodes and transmits the data stream and the second electronic device receives and decodes the data stream. However, in certain cases, the two electronic devices may transmit and receive encoded data streams simultaneously using the encoder system 104 and the decoder system 106, respectively, in each of the two electronic devices.

The server 108 may include suitable logic, circuitry, and interfaces, and/or code that may be configured to receive the set of hash functions 116 and the set of data streams 114 to be hashed. The server 108 may select, by using the hash selector 104A in the encoder system 104, each of the first hash function and the second hash function, from the received set of hash functions 116. The server 108 may apply the selected first hash function on the first set of data streams from the received set of data streams 114. The server 108 may generate the first hashed data stream based on the application of the selected first hash function on the first set of data streams. The server 108 may apply the selected second hash function on the second set of data streams from the received set of data streams 114. The server 108 may generate the second hashed data stream based on the application of the selected second hash function on the second set of data streams. The server 108 may generate the encoded data stream associated with the set of data streams 114, based on the generated first hashed data stream and the generated second hashed data stream. The server 108 may transmit the generated encoded data stream to the decoder system 106 associated with the encoder system 104, wherein the decoder system 106 may be configured to determine the set of data streams 114 from the transmitted encoded data streams, based on each of the first hash function and the second hash function.

The server 108 may be implemented as a cloud server and may execute operations through web applications, cloud applications, HTTP requests, repository operations, file transfer, and the like. Other example implementations of the server 108 may include, but are not limited to, a database server, a file server, a web server, a media server, an application server, a mainframe server, or a cloud computing server.

In at least one embodiment, the server 108 may be implemented as a plurality of distributed cloud-based resources by use of several technologies that may be well known to those ordinarily skilled in the art. A person with ordinary skill in the art will understand that the scope of the disclosure may not be limited to the implementation of the server 108 and the electronic device 102 as two separate entities. In certain embodiments, the functionalities of the server 108 can be incorporated in its entirety or at least partially in the electronic device 102, without a departure from the scope of the disclosure.

The database 110 may include suitable logic, interfaces, and/or code that may be configured to store the set of data streams 114 and the set of hash functions 116. The database 110 may be derived from data off a relational or non-relational database, or a set of comma-separated values (csv) files in conventional or big-data storage. The database 110 may be stored or cached on a device, such as a server (e.g., the server 108) or the electronic device 102. The device storing the database 110 may be configured to receive a query for the set of data streams 114 and/or the set of hash functions 116 from the electronic device 102. In response, the device of the database 110 may be configured to retrieve and provide the queried set of data streams 114 and/or the set of hash functions 116 to the electronic device 102 based on the received query. In some embodiments, the database 110 may be hosted on a plurality of servers stored at same or different locations. The operations of the database 110 may be executed using hardware including a processor, a microprocessor (e.g., to perform or control performance of one or more operations), a field-programmable gate array (FPGA), or an application-specific integrated circuit (ASIC). In some other instances, the database 110 may be implemented using software.

The communication network 112 may include a communication medium through which the electronic device 102 and the server 108, (and the device hosting the database 110) may communicate. The communication network 112 may be one of a wired connection or a wireless connection. Examples of the communication network 112 may include, but are not limited to, the Internet, a cloud network, Cellular or Wireless Mobile Network (such as, Long-Term Evolution and 5G New Radio), a Wireless Fidelity (Wi-Fi) network, a satellite network (e.g., a network of a set of low earth orbit satellites), a Personal Area Network (PAN), a Local Area Network (LAN), or a Metropolitan Area Network (MAN). Various devices in the environment 100 may be configured to connect to the communication network 112 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The set of data streams 114 may correspond to a sequence of digital signals that represent information as a sequence of coded bit-streams. In an embodiment, the set of data streams 114 may correspond to at least one of a text file, an audio file, a video file, an image file, or media content.

The set of hash functions 116 may include functions that may convert input data of arbitrary size to a hash value of a fixed or variable size. In an embodiment, the set of hash functions 116 may be at least one of a message-digest 5 (MD-5) hash function, a secure hash algorithm 256 (SHA-256) function, a secure hash algorithm 3 (SHA-3) function, or a BLAKE-2 hash function. The MD-5 hash function may be a cryptographic hash function that may produce a “128” bits (16 bytes) hash value. The SHA-256 function may be a member of the SHA-2 family and may produce a “256” bits (32 bytes) hash value. The SHA-3 function may be a family of hash functions standardized by national institute of standards and technology (NIST). The SHA-3 function may include hash functions such as, SHA-3-224, SHA-3-256, SHA-3-384, and SHA-3-512, that may produce hash values of different lengths. The BLAKE-2 hash function may be a cryptographic hash function that may be faster than the MD-5 hash function, SHA-1 function, and SHA-2 function. A BLAKE-2b hash function may produce a “512” bits hash value. A BLAKE-2s hash function may produce a “256” bits hash value.

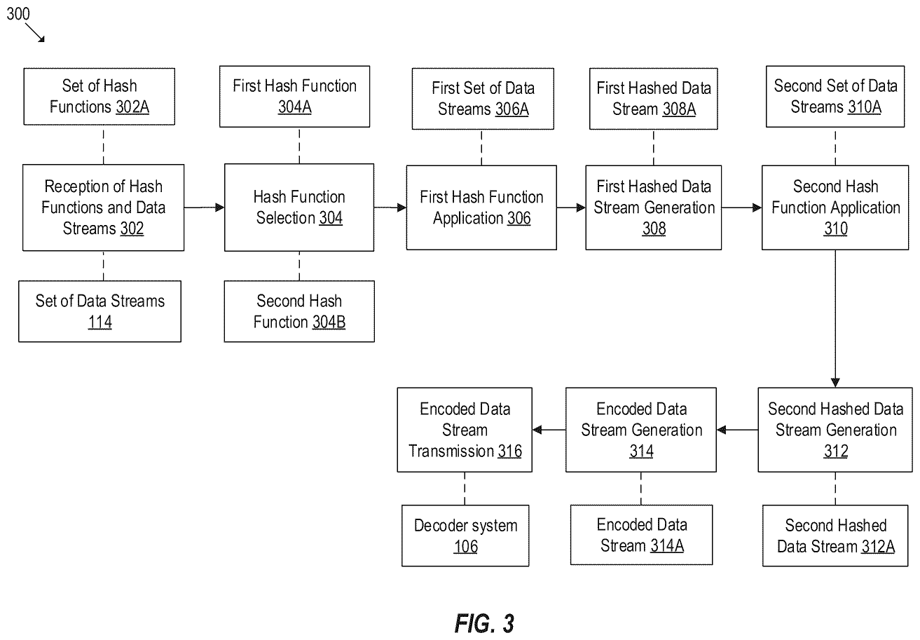

In operation, the electronic device 102 may receive the set of hash functions 116 and the set of data streams 114 to be hashed. In an example, the electronic device 102 may request the database 110 for the set of hash functions 116 and the set of data streams 114. The database 110 may verify the request and transmit the set of hash functions 116 and the set of data streams 114 to the electronic device 102 based on the verification. Details related to the reception of the set of hash functions 116 and the set of data streams 114 are further provided, for example, in FIG. 3 (at 302).

The electronic device 102 may select, by using the hash selector 104A in the encoder system 104, each of the first hash function and the second hash function, from the received set of hash functions 116. The hash selector 104A apply a set of rules to select the first hash function and the second hash function. In an example, the hash selector 104A may select the BLAKE-2 hash function as the first hash function and the MD-5 hash function as the second hash function. Details related to the selection of the first hash function and the second hash function are further provided, for example, in FIG. 3 (at 304).

The electronic device 102 may apply the selected first hash function on the first set of data streams from the received set of data streams 114. Herein, the first set of data streams may be provided as an input to the selected first hash function. Details related to the application of the selected first hash is further provided, for example, in FIG. 3 (at 306).

The electronic device 102 may generate the first hashed data stream based on the application of the selected first hash function on the first set of data streams. When the first set of data streams is provided as an input to the selected first hash function, then an output of the selected first hash function may be the first hashed data stream. In an example, the hash selector 104A may select the BLAKE-2b hash function as the first hash function. The BLAKE-2b hash function may be applied on the first set of data streams. Based on the application of the BLAKE-2b hash function, the first hashed data stream of “512” bits hash value may be generated. Details related to the generation of the first hashed data stream is further provided, for example, in FIG. 3 (at 308).

The electronic device 102 may apply the selected second hash function on the second set of data streams from the received set of data streams 114. Herein, the second set of data streams may be provided as an input to the selected second hash function. Details related to the application of the selected second hash is further provided, for example, in FIG. 3 (at 310).

The electronic device 102 may generate the second hashed data stream based on the application of the selected second hash function on the second set of data streams. When the second set of data streams is provided as an input to the selected second hash function, then an output of the selected second hash function may be the second hashed data stream. In an example, the hash selector 104A may select the MD-5 hash function as the second hash function. The MD-5 hash function may be applied on the second set of data streams. Based on the application of the MD-5 hash function, the second hashed data stream of “128” bits hash value may be generated. Details related to the generation of the second hashed data stream is further provided, for example, in FIG. 3 (at 312).

The electronic device 102 may generate the encoded data stream associated with the set of data streams 114, based on the generated first hashed data stream and the generated second hashed data stream. The generated first hashed data stream and the generated second hashed data stream may be encoded. The encoding of the generated first hashed data stream and the generated second hashed data stream may ensure that the encoded data stream may be in a format suitable for transmission. Details related to the generation of the encoded data stream is further provided, for example, in FIG. 3 (at 314).

The electronic device 102 may transmit the generated encoded data stream to the decoder system 106 associated with the encoder system 104. The decoder system 106 may be configured to determine the set of data streams (for example, the set of data streams 114) from the transmitted encoded data streams, based on each of the first hash function and the second hash function. Details related to the transmission of the encoded data stream is further provided, for example, in FIG. 3 (at 316).

The electronic device 102 may thus facilitate bandwidth efficient hash code generation. The electronic device 102 may transmit the generated encoded data stream to the decoder system 106 associated with the encoder system 104. A bandwidth needed for transmission of the encoded data stream may be lesser than a bandwidth needed for transmission of a hashed stream of each of the set of data streams 114 individually. Thus, an occurrence of a denial of service (DoS) condition during transmission of the encoded data stream may be prevented. Further, the electronic device 102 may be used in application areas where bandwidth efficient transfer of information may be required. For example, the electronic device 102 may be used in O-RAN, hash-based message authentication code (HMAC), digital signatures, and the like.

Modifications, additions, or omissions may be made to FIG. 1 without departing from the scope of the present disclosure. For example, the environment 100 may include more or fewer elements than those illustrated and described in the present disclosure. For instance, in some embodiments, the environment 100 may include the electronic device 102 but not the database 110. In addition, in some embodiments, the functionality of each of the database 110 and the server 108 may be incorporated into the electronic device 102, without a deviation from the scope of the disclosure.

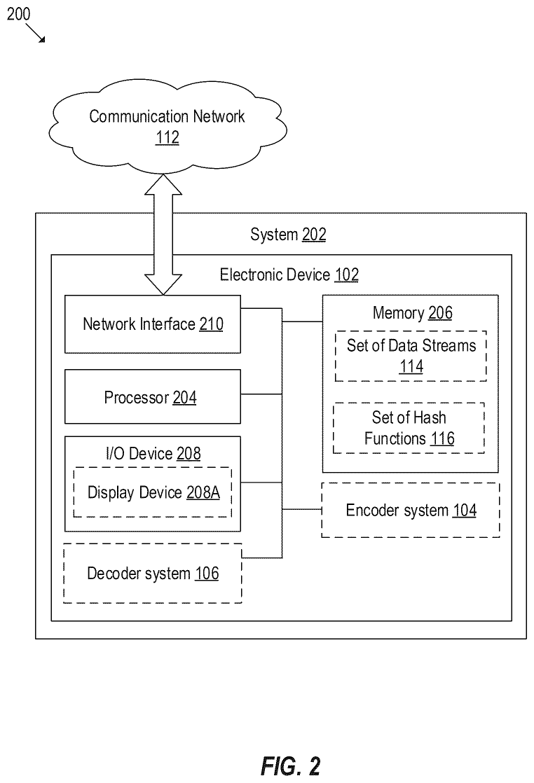

FIG. 2 is a block diagram that illustrates an exemplary electronic device for the bandwidth efficient hash code generation, in accordance with at least one embodiment described in the present disclosure. FIG. 2 is explained in conjunction with elements from FIG. 1. With reference to FIG. 2, there is shown a block diagram 200 of a system 202 that includes the electronic device 102. The electronic device 102 may include a processor 204, a memory 206, a network interface 208, an input/output (I/O) device 210 (including, a display device 210A), the encoder system 104, and the decoder system 106. In at least one embodiment, the memory 206 may store the set of data streams 114 and the set of hash functions 216.

The processor 204 may include suitable logic, circuitry, and interfaces that may be configured to execute a set of instructions stored in the memory 206. The processor 204 may be configured to execute program instructions associated with different operations to be executed by the electronic device 102. For example, some of the operations may include reception of the set of hash functions and the set of data streams, selection of hash functions, first hash function application, first hashed data stream generation, second hash function application, second hashed data stream generation, encoded data stream generation, and encoded data stream transmission. The processor 204 may be implemented based on a number of processor technologies known in the art. Examples of the processor technologies may include, but are not limited to, a Central Processing Unit (CPU), X86-based processor, a Reduced Instruction Set Computing (RISC) processor, an Application-Specific Integrated Circuit (ASIC) processor, a Complex Instruction Set Computing (CISC) processor, a Graphical Processing Unit (GPU), a co-processor, or a combination thereof.

Although illustrated as a single processor in FIG. 2, the processor 204 may include any number of processors configured to, individually or collectively, perform or direct performance of any number of operations of the electronic device 102, as described in the present disclosure. Additionally, one or more of the processors may be present on one or more different electronic devices, such as different servers. In some embodiments, the processor 204 may be configured to interpret and/or execute program instructions and/or process data stored in the memory 206. After the program instructions are loaded into the memory 206, the processor 204 may execute the program instructions.

The memory 206 may include suitable logic, circuitry, and interfaces that may be configured to store the one or more instructions to be executed by the processor 204. The one or more instructions stored in the memory 206 may be executed by the processor 204 to perform the different operations of the processor 204 (and the electronic device 102). The memory 206 that may be configured to store the set of data streams 114 and the set of hash functions 216. Examples of implementation of the memory 206 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 208 may include suitable logic, circuitry, and interfaces that may be configured to facilitate communication between the processor 204, the server 108, and a device hosting the database 110 (and/or any other device in the environment 100), via the communication network 112. The network interface 208 may be implemented by use of various known technologies to support wired or wireless communication of the electronic device 102 with the communication network 112. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet, or a wireless network, such as a cellular telephone network, a wireless local area network (LAN), a satellite network, and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

The I/O device 210 may include suitable logic, circuitry, and interfaces that may be configured to receive an input from the user 118 and provide an output based on the received input. For example, the input received from the user 118 may include a uniform resource locator (URL) of an input data stream to be encoded and/or a user-selection of multiple hash functions to be used for the encoding. The output may include the encoded data stream at the encoder system 104 and the decoded original data stream at the decoder system 106. For example, the decoded original data stream may be a video file, which may be streamed or played-back on the display device 210A. The I/O device 210 which may include various input and output devices, may be configured to communicate with the processor 204. Examples of the I/O device 210 may include, but are not limited to, a touch screen, a keyboard, a mouse, a joystick, a microphone, a display device (e.g., the display device 210A), and a speaker.

The display device 210A may include suitable logic, circuitry, and interfaces that may be configured to display the information associated with the generated set of data streams 114. The display device 210A may be a touch screen which may enable a user to provide a user-input via the display device 210A. The touch screen may be at least one of a resistive touch screen, a capacitive touch screen, or a thermal touch screen. The display device 210A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210A may refer to a display screen of a head mounted device (HMD), a smart-glass device, a see-through display, a projection-based display, an electro-chromic display, or a transparent display.

Modifications, additions, or omissions may be made to the example electronic device 102 without departing from the scope of the present disclosure. For example, in some embodiments, the example electronic device 102 may include any number of other components that may not be explicitly illustrated or described for the sake of brevity.

FIG. 3 is a diagram that illustrates an execution pipeline for bandwidth efficient hash code generation, in accordance with an embodiment of the disclosure. FIG. 3 is described in conjunction with elements from FIG. 1 and FIG. 2. With reference to FIG. 3 there is shown an execution pipeline 300. The exemplary execution pipeline 300 may include a set of operations that may be executed by one or more components of FIG. 1, such as, the electronic device 102. The operations may include an operation for reception of hash functions and streams 302, a hash function selection operation 304, a first hash function application operation 306, a first hashed data stream generation operation 308, a second hash function application operation 310, a second hashed data stream generation operation 312, an encoded data stream generation operation 314, and an encoded data stream transmission operation 316. The set of operations may be performed by the electronic device 102 for bandwidth efficient hash code generation, as described herein. As shown in FIG. 3, the exemplary execution pipeline 300 may further include the hash selector 104A, the set of data streams 114, the set of hash functions 116, a first hash function 304A, a second hash function 304B. The execution pipeline 300 may further include a first set of data streams 306A, a first hashed data stream 308A, a second set of data streams 310A, a second hashed data stream 312A, an encoded data stream 314A, and the decoder system 106.

At 302, an operation for reception of hash functions and data streams may be executed. In an embodiment, the processor 204 may be configured to receive the set of hash functions 116 and the set of data streams 114 to be hashed. It may be appreciated that a hash function may be function that may map data of any size to a fixed sized hash value. In some embodiments, an output of the hash function may be of variable length. Further, a data stream may include a set of data elements that may be transmitted sequentially over a period of time.

In an embodiment, the received set of data streams 114 may correspond to at least one of the text file, the audio file, the video file, the image file, or the media content. The text file may be a non-executable file that may include one or more lines of electronic texts. The audio file may be sound files that may include audio data. Examples of the audio file may include a wave file, a MP3 file, and the like. The video file may include a set of images and audio data. An example of the video file may be a MP4 file. The image file may include one or more images. Examples of the image file may include a joint photographic experts group (JPEG) file, a portable network graphic (PNG) file, and a graphics interchange format (GIF) file.

In an embodiment, the received set of hash functions 116 may correspond to at least one of the message-digest 5 (MD-5) hash function, the secure hash algorithm 256 (SHA-256) function, the secure hash algorithm 3 (SHA-3) function, or the BLAKE-2 hash function. The MD-5 hash function may determine a hash value of “128” bits for input data of arbitrary size. The hash value of “128” bits may be represented in “32” digit hexadecimal numbers. For example, the hash value may be “ec55d3e698d289f2afd663725127bace”. The SHA-256 function may determine a hash value of “256” bits (32 bytes) for the input data of arbitrary size. In an example, the hash value of “256” bits may be “40b7df43f24bea395b2c0c3c9d48a3db4db631fa396dd0dd8fe7dc64c9de6f6d”. The SHA-3 function may determine a hash value of “224” bits, “256” bits, “384” bits, or “512” bits for the input data of arbitrary size. In an example, the hash value of “224” bits may be “c4797897c58a0640df9c4e9a8f30570364d9ed8450c78ed155278ac0”. The BLAKE-2 hash function may be a hash function based on BLAKE hash function. The BLAKE-2 hash function may use 8-byte words, and 128-byte chunk. The processor 204 may receive the set of hash functions 116 and the set of data streams 114 to be hashed. In an embodiment, the processor 204 may request the database 110 for the set of hash functions 116 and the set of data streams 114. The database 110 may verify the request and transmit the queried set of hash functions 116 and the set of data streams 114 to the processor 204.

At 304, an operation for hash function selection may be executed. In an embodiment, the processor 204 may be configured to select, by using the hash selector 104A in the encoder system 104, each of the first hash function 304A and the second hash function 304B, from the received set of hash functions 116. In an example, the received set of hash functions 116 may include the MD-5 hash function, the SHA-256 function, the SHA-3 function, or the BLAKE-2 hash function. The hash selector 104A may select the MD-5 hash function as the first hash function 304A and the BLAKE-2 hash function as the second hash function 304B.

In an embodiment, the processor 204 may be configured to concatenate, by the concatenator 104B in the encoder system 104, a first plurality of data streams from the received set of data streams 114, wherein the first set of data streams 306A may be generated based on the concatenation of the first plurality of data streams. The processor 204 may be further configured to concatenate, by the concatenator 104B, the second plurality of data streams from the received set of data streams 114, wherein the second set of data streams 310A may be generated based on the concatenation of the second plurality of data streams. The first plurality of data streams and the second plurality of data streams may be selected from the received set of data streams 114 based on a desired transmission bandwidth. In an example, the received set of data streams 114 may include “N” number of text files, a text file “f₁”, a text file “f₂”, . . . , up to a text file “f_{N}”. For example, “n” number of data streams may be selected from the received set of data streams 114 such that, the desired bandwidth (r) may be in accordance with an equation (1), as follows:

$$r = \frac{n}{N} \qquad ( 1 )$$

where r may be desired bandwidth, “n” may be number of data streams to be selected, and “N” may be the number of data streams in the received set of data streams 114.

In an example, the received set of data streams 114 may include a text file “f₁”, a text file “f₂”, and a text file “f₃”. Herein, the first plurality of data streams may include the text file “f₁”, and the text file “f₂”. The second plurality of data streams may include the text file “f₂”, and the text file “f₃”. The first plurality of data streams may be provided as an input to the concatenator 104B. The concatenator 104B may concatenate the first plurality of data streams to generate the first set of data streams 306A. The concatenation of the first plurality of data streams may be in accordance with an equation (2), as follows:

$$f 1 + f 2 = 0 \qquad ( 2 )$$

where “+” may denote concatenation. Further, the second plurality of data streams may be provided as an input to the concatenator 104B. The concatenator 104B may concatenate the second plurality of data streams to generate the second set of data streams 310A. The concatenation of the second plurality of data streams may be in accordance with an equation (3), as follows:

$$f 2 + f 3 = 0 \qquad ( 3 )$$

where “+” may denote concatenation. Thus, based on the concatenation, the first set of data streams 306A and the second set of data streams 310A may be generated.

In an embodiment, the first plurality of data streams and the second plurality of data streams may be concatenated serially. Herein, initially, the first plurality of data streams may be concatenated by applying the concatenator 104B on the first plurality of data streams. Thereafter, the second plurality of data streams may be concatenated by applying the concatenator 104B on the second plurality of data streams.

In another embodiment, the first plurality of data streams and the second plurality of data streams may be concatenated in parallel. Herein, the first plurality of data streams may be concatenated by applying a first concentrator (for example, the concatenator 104B) on the first plurality of data streams. Further, the second plurality of data streams may be concatenated simultaneously by applying a second concentrator (for example, the concatenator 104B) on the second plurality of data streams.

At 306, an operation for first hash function application may be executed. In an embodiment, the processor 204 may be configured to apply the selected first hash function 304A on the first set of data streams 306A from the received set of data streams 114. In an example, the received set of data streams 114 may include a text file “f₁”, a text file “f₂”, and a text file “f₃”. Herein, the first plurality of data streams may include the text file “f₁”, and the text file “f₂”. In an example, the hash selector 104A may select the MD-5 hash function as the first hash function 304A. Herein, the first set of data streams 306A may be generated based on a concatenation of the first plurality of data streams including the text file “f₁” and the text file “f₂”. The first set of data streams 306A may be provided as an input to the MD-5 hash function.

At 308, an operation for the first hashed data stream generation may be executed. In an embodiment, the processor 204 may be configured to generate the first hashed data stream 308A based on the application of the selected first hash function 304A on the first set of data streams 306A. In an example, the hash selector 104A may select the MD-5 hash function as the first hash function 304A. Herein, the first set of data streams 306A may be provided as an input to the MD-5 hash function. The MD-5 hash function may convert the first set of data streams 306A of an arbitrary size to the first hashed data stream of a fixed size, such as, “128” bits.

At 310, an operation for second hash function application may be executed. In an embodiment, the processor 204 may be configured to apply the selected second hash function 304B on the second set of data streams 310A from the received set of data streams 114. In an example, the hash selector 104A may select the SHA-256 hash function as the second hash function 304B. Further, the second set of data streams 310A may be the concatenation of the text file “f₂” and the text file “f₃”. The second set of data streams 310A may be provided as an input to the SHA-256 hash function.

At 312, an operation for second hashed data stream generation may be executed. In an embodiment, the processor 204 may be configured to generate the second hashed data stream 312A based on the application of the selected second hash function 304B on the second set of data streams 310A. In an example, the received set of data streams 114 may include a text file “f₁”, a text file “f₂”, and a text file “f₃”. Herein, the second plurality of data streams may include the text file “f₂”, and the text file “f₃”. In an example, the hash selector 104A may select the SHA-256 hash function as the second hash function 304B. Herein, the second set of data streams 310A may be generated based on a concatenation of the second plurality of data streams including the text file “f₂” and the text file “f₃”. Herein, the second set of data streams 310A may be provided as an input to the SHA-256 hash function. The SHA-256 hash function may convert the second set of data streams 310A of an arbitrary size to the second hashed data stream of “256” bits.

In an embodiment, the application of the first hash function 304A and the application of the second hash function 304B may be performed in parallel. That is, the selected first hash function 304A may be applied on the first set of data streams 306A and the selected second hash function 304B may be applied on the second set of data streams 310A simultaneously. Based on the parallel application of the first hash function 304A and the second hash function 304B, the first hashed data stream 308A and the second hashed data stream 312A may be generated efficiently. However, the scope of the disclosure should not be limited to the parallel application of the first hash function 304A and the second hash function 304B. In certain scenarios, the first hash function 304A and the second hash function 304B may be applied in a sequential order, without departure from the scope of the disclosure.

At 314, an operation for encoded data stream generation may be executed. In an embodiment, the processor 204 may be configured to generate the encoded data stream 314A associated with the set of data streams 114, based on the generated first hashed data stream 308A and the generated second hashed data stream 312A. In an example, the generated first hashed data stream 308A may be of “128” bits. The generated second hashed data stream 312A may be of “256” bits. The “128” bits of the generated first hashed data stream 308A and the “256” bits of the generated second hashed data stream 312A may be encoded.

In an embodiment, the processor 204 may be further configured to multiplex, by the multiplexer 104C in the encoder system 104, the first hashed data stream 308A and the second hashed data stream 312A, wherein the generation of the encoded data stream 314A may be further based on the multiplexing of the first hashed data stream 308A and the second hashed data stream 312A. It may be appreciated that the multiplexer 104C may convert a set of signals to a single complex signal so that the set of signals may be transmitted at a same time over a communication channel. Examples of the multiplexer 104C may be a “2-to-1” multiplexer, a “4-to-1” multiplexer, an “8-to-1” multiplexer. The multiplexer 104C of the present disclosure may convert the first hashed data stream 308A and the second hashed data stream 312A into the encoded data stream 314A.

In an embodiment, each of the received set of data streams 114 may be represented in the generated encoded data stream 314A. Herein, the selected first hash function 304A may be applied on the first set of data streams 306A and the selected second hash function 304B may be applied on the second set of data streams 310A. The first set of data streams 306A and the second set of data streams 310A may constitute the received set of data streams 114. Thus, the encoded data stream 314A generated based on the generated first hashed data stream 308A and the generated second hashed data stream 312A may represent each of the received set of data streams 114.

At 316, an operation for encoded data stream transmission may be executed. In an embodiment, the processor 204 may be further configured to transmit the generated encoded data stream 314A to the decoder system 106 associated with the encoder system 104. Herein, the decoder system 106 may be configured to determine the set of data streams 114 from the transmitted encoded data streams 314A. The determination of the set of data streams 114 by the decoder system 106 may be based on each of the first hash function 304A and the second hash function 304B. The decoder system 106 may receive the transmitted encoded data streams 314A. Thereafter, the transmitted encoded data streams 314A may be converted to the set of data streams 114.

In an example, the received set of data streams 114 may include a text file “f₁”, a text file “f₂”, and a text file “f₃”. Herein, the first plurality of data streams may include the text file “f₁”, and the text file “f₂”. The second plurality of data streams may include the text file “f₂”, and the text file “f₃”. The concatenator 104B may concatenate the first plurality of data streams to generate the first set of data streams 306A. Further, the concatenator 104B may concatenate the second plurality of data streams to generate the second set of data streams 310A. The first hashed data stream 308A may be generated based on the first set of data streams 306A and the second hashed data stream 312A may be generated based on the second set of data streams 310A. The first hashed data stream 308A and the second hashed data stream 312A may be encoded to generate the encoded data stream 314A. The encoded data stream 314A may be transmitted to the decoder system 106. Thus, in current example, instead of transmitting a hash stream associated with the text file “f₁”, a hash stream associated with the text file “f₂”, and a hash stream associated with the text file “f₃” independently, only the encoded data stream 314A associated with the first hashed data stream 308A and the second hashed data stream 312A may be transmitted to the decoder system 106. Therefore, a bandwidth reduction ratio of “1/3” may be achieved. The decoder system 106 may receive the transmitted encoded data streams 314A. Thereafter, the transmitted encoded data streams 314A may be converted to the set of data streams 114.

In another example, the received set of data streams 114 may include a text file “f₁”, a text file “f₂”, and a text file “f₃”. Herein, the first plurality of data streams may include the text file “f₁”, the text file “f₂”, and the text file “f₃”. The concatenator 104B may concatenate the first plurality of data streams to generate the first set of data streams 306A. The first hashed data stream 308A may be generated based on the first set of data streams 306A. The first hashed data stream 308A may be encoded to generate the encoded data stream 314A. The encoded data stream 314A may be transmitted to the decoder system 106. Thus, instead of transmitting a hash stream associated with the text file “f₁”, a hash stream associated with the text file “f₂”, and a hash stream associated with the text file “f₃” independently, only the encoded data stream 314A associated with the first hashed data stream 308A may be transmitted to the decoder system 106. Therefore, a bandwidth reduction ratio of “2/3” may be achieved. The decoder system 106 may receive the transmitted encoded data streams 314A. Thereafter, the transmitted encoded data streams 314A may be converted to the set of data streams 114. Thus, for a given “N” number of data streams in set of data streams 114 and “n” number of equations for concatenation, a maximum of “n” number of hashed data streams can be constructed. The transmission of the encoded data streams 314A instead of an individual hashed data stream of each of the set of data streams 114 may lead to efficient usage of bandwidth.

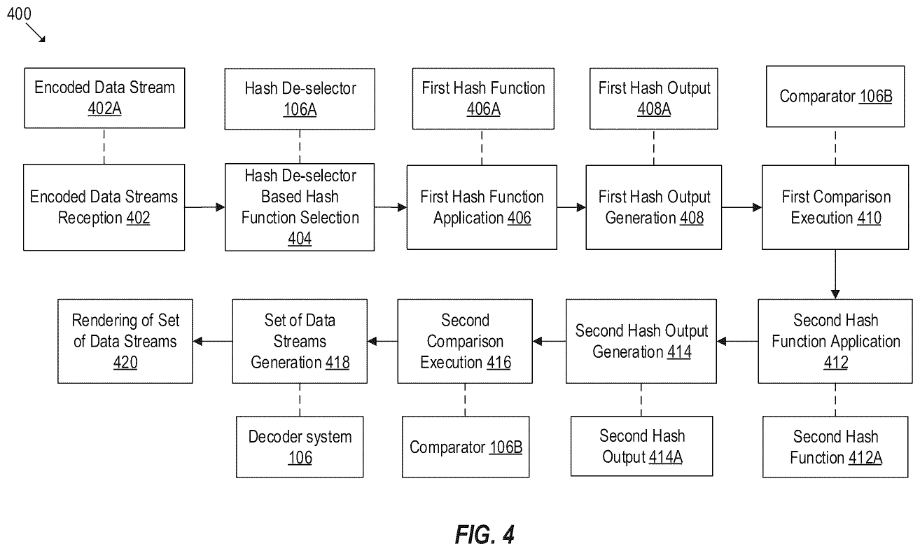

In an embodiment, the processor 204 may be further configured to transmit, the received set of hash functions 116 to the decoder system 106 based on the transmission of the generated encoded data stream 314A, wherein the determination of the set of data streams 114 by the decoder system 106 may be further based on the transmission of the set of hash functions 116. Details related to the determination of the set of data streams 114, are further provided, for example, in FIG. 4.

It may be appreciated that network systems such as, an open radio access network (O-RAN), may include a plurality of interconnected blocks. Information from one block may be sent to another block based on the interconnection. In order to maintain an integrity of the information, the block transmitting the information may hash information prior to transmission of the information. Typically, for a given number of data sets, a bandwidth of cumulative hashes may be fixed. Such fixed bandwidth may be unaffordable. That is, in order to avoid congestion and for effective transmission, the bandwidth of cumulative hashes may need to be minimized.

The present disclosure may provide a method that facilitates bandwidth efficient hash code generation. For such bandwidth efficient hash code generation, an electronic device (such as, the electronic device 102 including the encoder system 104) of the present disclosure may employ a method that may generate the first hashed data stream 308A based on the application of the selected first hash function 304A on the first set of data streams 306A. The method may generate the second hashed data stream 312A based on the application of the selected second hash function 304B on the second set of data streams 310A. The method may generate the encoded data stream 314A associated with the set of data streams 114, based on the generated first hashed data stream 308A and the generated second hashed data stream 312A. The method may transmit the generated encoded data stream 314A to the decoder system 106 associated with the encoder system 104. A bandwidth needed for transmitting the encoded data stream 114 may be lesser than a bandwidth needed for transmitting a hashed stream of each of the set of data streams individually. Thus, an application of the disclosed method for the transmission of hashed data may prevent occurrence of a denial of service (DoS) condition. Further, the disclosed method may be used in application areas where bandwidth efficient transfer of information may be sought. For example, the disclosed method may be used in O-RAN, hash-based message authentication code (HMAC), digital signatures, and the like.

FIG. 4 is a diagram that illustrates an execution pipeline for generation of the set of data streams, in accordance with an embodiment of the disclosure. FIG. 4 is described in conjunction with elements from FIG. 1, FIG. 2, and FIG. 3. With reference to FIG. 4 there is shown an exemplary execution pipeline 400. The exemplary execution pipeline 400 may include a set of operations that may be executed by one or more components of FIG. 1, such as, the electronic device 102. The operations may include an encoded data stream reception operation 402, a hash de-selector based hash function selection operation 404, a first hash function application operation 406, a first hash output generation operation 408, a first comparison execution operation 410, a second hash function application operation 412, a second hash output generation operation 414, a second comparison execution operation 416, a set of data streams generation operation 418, and an operation for rendering of set of data streams 420. The set of operations may be performed by the electronic device 102 for bandwidth efficient hash code generation, as described herein. As shown in FIG. 4, the exemplary execution pipeline 400 may further include an encoded data stream 402A, a first hash function 406A, a first hash output 408A, the comparator 106B, a second hash function 412A, a second hash output 414A, and the decoder system 106.

At 402, an encoded data stream reception operation may be executed. In an embodiment, the processor 204 may be configured to receive the encoded data stream 402A from the encoder system 104 associated with the decoder system 106, wherein the received encoded data stream 402A may include a first hashed data stream and a second hashed data stream.

In an embodiment, the encoder system 104 may be configured to receive the set of hash functions 116 and the set of data streams 114 to be hashed. In an example, the set of hash functions 116 and the set of data streams 114 to be hashed may be stored in the database 110. The encoder system 104 may request the database 110 to provide the set of hash functions 116 and the set of data streams 114. The database 110 may verify the request and provide the set of hash functions 116 and the set of data streams 114 to the encoder system 104 based on the verification.

The encoder system 104 may be configured to select, by using the hash selector 104A in the encoder system 104, each of the first hash function 304A and the second hash function 304B, from the received set of hash functions 116. In an example, the encoder system 104 may receive the MD-5 hash function, the SHA-256 function, the SHA-3 function as the set of hash functions 116. The first hash function 304A may be selected as the SHA-3 function and the second hash function 304B may be selected as the MD-5 hash function. Details related to the selection of the first hash function and the second hash function are further provided, for example in FIG. 3 (at 304).

The encoder system 104 may be configured to apply the selected first hash function 304A on the first set of data streams 306A from the received set of data streams 114A. Herein, the first set of data streams 306A may be provided an input to the selected first hash function 304A. Details related to the application of the first hash function is further provided, for example in FIG. 3 (at 306).

The encoder system 104 may be configured to generate the first hashed data stream 308A based on the application of the selected first hash function 304A on the first set of data streams 306A. In an example, the encoder system 104 may receive the MD-5 hash function, the SHA-256 function, the SHA-3 function as the set of hash functions 116 and a video “a”, a video “b”, and a video “c” as the set of data streams 114 to be hashed. The first hash function 304A may be selected as the SHA-3 function. The first set of data streams 306A may be the video “a” and the video “b”. The encoder system 104 may apply the SHA-3 function on the video “a” and the video “b” to generate the first hashed data stream 308A. Details related to the generation of the first hashed data stream 308A is further provided, for example in FIG. 3 (at 308).

The encoder system 104 may be configured to apply the selected second hash function 304B on the second set of data streams 310A from the received set of data streams 114. The second set of data streams 310A may be provided as an input to the selected second hash function 304B. Details related to the application of the selected second hash function is further provided, for example in FIG. 3 (at 310).

The encoder system 104 may be configured to generate the second hashed data stream 312A based on the application of the selected second hash function 304B on the second set of data streams 310A. In an example, the encoder system 104 may receive the MD-5 hash function, the SHA-256 function, the SHA-3 function as the set of hash functions 116 and the video “a”, the video “b”, and the video “c” as the set of data streams 114 to be hashed. The second hash function 304B may be selected as the MD-5 hash function. The second set of data streams 310A may be the video “b” and the video “c”. The encoder system 104 may apply the MD-5 hash function on the video “b” and the video “c”. The encoder system 104 may generate the second hashed data stream 312A based on the application of the MD-5 hash function on the video “b” and the video “c”. Details related to the generation of the second hashed data stream 312A is further provided, for example in FIG. 3 (at 312).

The encoder system 104 may be configured to generate the encoded data stream 402A associated with the set of data streams 114, based on the generated first hashed data stream 308A and the generated second hashed data stream 312A.

In an embodiment, the encoder system 104 may be configured to generate the encoded data stream 402A based on the first hash function 304A and the second hash function 304B. Herein, the first hash function 304A may be applied on the first set of data streams 306A. The first hashed data stream 308A may be generated based on the application of the selected first hash function 304A on the first set of data streams 306A. The selected second hash function 304B may be applied on the second set of data streams 310A. The encoder system 104 may generate the second hashed data stream 312A based on the application of the selected second hash function 304B on the second set of data streams 310A. The encoder system 104 may generate the encoded data stream 402A associated with the set of data streams 114, based on the generated first hashed data stream 308A and the generated second hashed data stream 312A. For example, the generated first hashed data stream 308A and the generated second hashed data stream 312A may be encoded to generate the encoded data stream 402A.

In an embodiment, each of the first hashed data stream and the second hashed data stream may be multiplexed within the received encoded data stream 402A. Herein, the encoder system 104 may multiplex the first hashed data stream and the second hashed data stream based on the application of the multiplexer 104C. It may be appreciated that the multiplexer 104C may convert a set of signals to a single complex signal so that the set of signals may be transmitted at a same time over the communication channel. In an example, the multiplexer 104C of the present disclosure may be a “2-to-1” multiplexer that may convert the first hashed data stream 308A and the second hashed data stream 312A into the encoded data stream 314A. Details related to the generation of the encoded data stream 402A is further provided, for example in FIG. 3 (at 314).

The encoder system 104 may be configured to transmit the generated encoded data stream 402A to the decoder system 106 associated with the encoder system 104. Upon generation of the encoded data stream 402A, the encoder system 104 may transmit the generated encoded data stream 402A to the decoder system 106. Details related to the transmission of the encoded data stream 402A is further provided, for example in FIG. 3 (at 316).

At 404, an operation for the hash functions selection (i.e., the hash de-selector based hash function selection operation) may be executed. In an embodiment, the processor 204 may be configured to select, by using the hash de-selector 106A in the decoder system 106, each of the first hash function 406A and the second hash function 412A, from the set of hash functions 116. The first hash function 406A and the second hash function 412A selected by the decoder system 106 may be same as the first hash function 304A and the second hash function 304B selected by the encoder system 104. That is, if the encoder system 104 selects the SHA-3 function as the first hash function 304A and the MD-5 hash function as the second hash function 304B then the decoder system 106 may also select the SHA-3 function as the first hash function 406A and the MD-5 hash function as the second hash function 412A.

In an embodiment, the processor 204 may be configured to receive the set of hash functions 116 from the encoder system 104, based on the reception of the encoded data stream 402A. Herein, the set of hash functions 116 may be received from the encoder system 104 via a channel that may be separate from a channel used for transmission of the encoded data stream 402A. The processor 204 may then select each of the first hash function 406A and the second hash function 412A from the received set of hash functions 116.

At 406, an operation for first hash function application may be executed. In an embodiment, the processor 204 may be configured to apply the selected first hash function 406A on the received encoded data streams 402A. Herein, the received encoded data streams 402A may be provided as an input to the selected first hash function 406A. In an example, the selected first hash function 406A may be the SHA-3 function. The received encoded data streams 402A may be provided as an input to the SHA-3 function.

At 408, an operation for first hash output generation may be executed. In an embodiment, the processor 204 may be configured to generate the first hash output 408A based on the application of the selected first hash function 406A on the received encoded data streams 402A. In an example, the selected first hash function 406A may be the SHA-3 function. The received encoded data streams 402A may be provided as an input to the SHA-3 function. Based on the application of the SHA-3 function, the first hash output 408A of size “224” bits may be generated.

At 410, a first comparison operation may be executed. In an embodiment, the processor 204 may be configured to execute a first comparison, by using the comparator 106B in the decoder system 106, between the generated first hash output 408A and the first hashed data stream. The comparator 106B may be a device that may compare two input signals or data streams and provide an output. The output may indicate whether the two input signals or data streams are same. The first hashed data stream included in the received encoded data stream 402A and the generated first hash output 408A may be provided as input to the comparator 106B. The comparator 106B may compare the first hashed data stream included in the received encoded data stream 402A and the generated first hash output 408A to determine whether the first hashed data stream and the generated first hash output 408A are same.

At 412, an operation for second hash function application may be executed. In an embodiment, the processor 204 may be configured to apply the selected second hash function 412A on the received encoded data streams 402A. Herein, the received encoded data streams 402A may be provided as an input to the selected second hash function 412A. The application of the selected second hash function 412A may be similar to the application of the selected first hash function 406A, as described further, for example, at 406.

At 414, an operation for second hash output generation may be executed. In an embodiment, the processor 204 may be configured to generate the second hash output 414A based on the application of the selected second hash function 412A on the received encoded data streams 402A. In an example, the selected second hash function 412A may be the MD-5 hash function. The received encoded data streams 402A may be provided as an input to the MD-5 hash function. Based on the application of the MD-5 hash function, the second hash output 414A of size “128” bits may be generated.

In an embodiment, the application of the first hash function 406A and the application of the second hash function 412A may be performed in parallel. In an example, the selected first hash function 406A may be the SHA-3 function and the selected second hash function 412A may be the MD-5 hash function. Herein, the SHA-3 function may be applied on the received encoded data streams 402A and the MD-5 hash function may be applied on the received encoded data streams 402A at once. Such application of the SHA-3 function, and the MD-5 hash function in parallel may ensure that an execution time associated with the application of the first hash function 406A and the application may be reduced.

At 416, a second comparison operation may be executed. In an embodiment, the processor 204 may be configured to execute the second comparison, by using the comparator 106B, between the generated second hash output 414A and the second hashed data stream. The comparator 106B may compare the second hashed data stream included in the received encoded data stream 402A and the generated second hash output 414A to determine whether the second hashed data stream and the generated second hash output 414A are same. In an embodiment, a first comparator (for example, the comparator 106B) may compare the first hashed data stream included in the received encoded data stream 402A and the generated first hash output 408A. The second comparator (for example, the comparator 106B) may compare the second hashed data stream and the generated second hash output 414A. In certain cases, the comparison of the first hashed data stream with the generated first hash output 408A and the comparison of the second hashed data stream with the generated second hash output 414A may be executed in parallel. Alternatively, the first comparison operation and the second comparison operation may be executed sequentially,

At 418, an operation for generation of a set of data streams may be executed. In an embodiment, the processor 204 may be configured to generate, by using the decoding logic 106C in the decoder system 106, the set of data streams (for example, the set of data streams 114), based on the executed first comparison and the executed second comparison. The decoding logic 106C may concatenate the result of the executed first comparison and the executed second comparison to generate the set of data streams (for example, the set of data streams 114).

In an embodiment, the generated set of data streams (for example, the set of data streams 114) may correspond to at least one of a text file, an audio file, a video file, an image file, or media content. The text file may be a non-executable file that may include one or more characters of textual data. The audio file may be sound files that may include audio data. The video file may include the set of images and audio data. The image file may include one or more images.

In an embodiment, the first hash data stream may correspond to a concatenation of a first plurality of data streams from the generated set of data streams (for example, the set of data streams 114). The second hash data stream may correspond to a concatenation of a second plurality of data streams from the generated set of data streams (for example, the set of data streams 114). In an example, the generated set of data streams (for example, the set of data streams 114) may be an audio file “L”, an audio file “M”, and an audio file “N”. Herein, the first plurality of data streams may be the audio file “L” and the audio file “M” and the second plurality of data streams may be the audio file “L” and the audio file “N”. The first hash data stream may correspond to the concatenation of the audio file “L” and the audio file “M”. The second hash data stream may correspond to the concatenation of the audio file “L” and the audio file “N”.

At 420, an operation for rendering of set of data streams may be executed. In an embodiment, the processor 204 may be configured to render the information associated with the generated set of data streams (for example, the set of data streams 114). In an example, the generated set of data streams (for example, the set of data streams 114) may include a text file “A”, an audio file “L”, and a video file “P”. A user interface (UI) may be displayed on the display device 210A. The UI may include a first UI element, a second UI element, and a third UI element. The first UI element may provide information of the text file “A”, the second UI element may provide information of the audio file “L”, and the third UI element may provide information of the video file “P”. The user 118 may interact with the first UI element, the second UI element, and the third UI element to view the text file “A”, the audio file “L”, and the video file “P”.

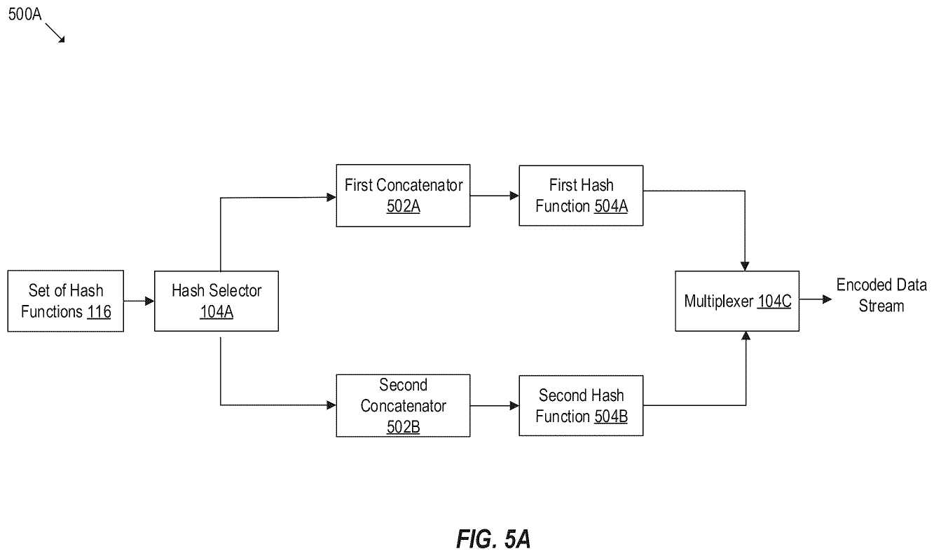

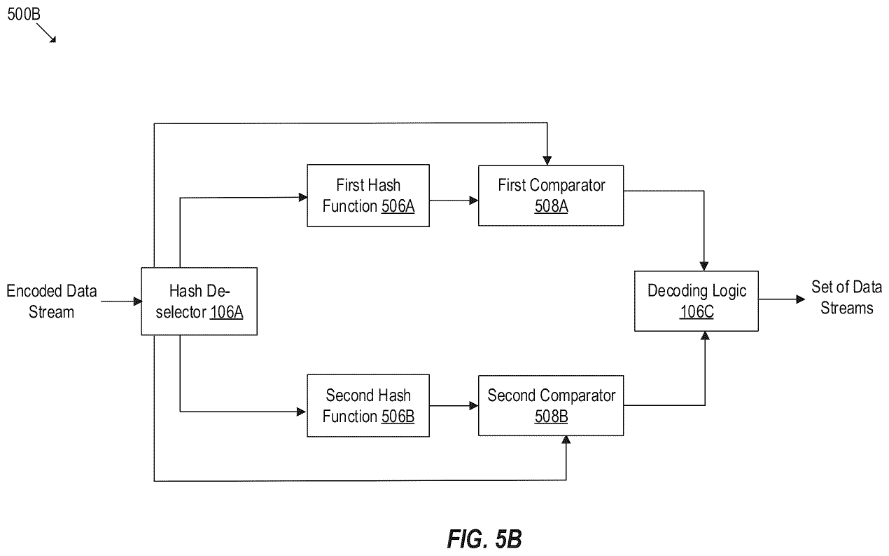

FIG. 5A is a diagram that illustrates an exemplary scenario for bandwidth efficient hash code generation, in accordance with at least one embodiment described in the present disclosure. FIG. 5A is described in conjunction with elements from FIG. 1, FIG. 2, FIG. 3, and FIG. 4. With reference to FIG. 5A, there is shown an exemplary scenario 500A. The exemplary scenario 500A may include the set of hash functions 116, the hash selector 104A, a first concatenator 502A, a second concatenator 502B, a first hash function 504A, a second hash function 504B, and the multiplexer 104C. A set of operations associated with the scenario 500A is described herein.

With reference to the scenario 500A, the hash selector 104A, the first concatenator 502A, the second concatenator 502B, and the multiplexer 104C may constitute the encoder system 104. As shown in FIG. 5A, a first block and a last block of the encoder system 104 may be the hash selector 104A and the multiplexer 104C, respectively. In between the hash selector 104A and the multiplexer 104C, “N” number of parallel paths may exist. The hash selector 104A may map equations associated with combinations of data streams to parallel paths. Each parallel path may capture one equation. Each equation associated with a parallel path may be converted into a concatenated data stream using concatenator (for example, the first concatenator 502A) such that the concatenated data stream may be hashed using a hash function (for example, the first hash function 504A) selected by the hash selector 104A for the corresponding path. For example, with reference to FIG. 5A, two parallel paths may exist. In an example, the set of data streams 114 may include a text file “G”, a text file “H”, and a text file “I”. The first concatenator 502A may concatenate the text file “G” and the text file “H”. The concatenation of the text file “G” and the text file “H” may be provided as an input to the first hash function 504A. The second concatenator 502B may concatenate the text file “H” and the text file “I”. The concatenation of the text file “H” and the text file “I” may be provided as an input to the second hash function 504B. The output of the first hash function 504A and the second hash function 504B may be multiplexed using the multiplexer 104C to determine an encoded data stream.

It should be noted that the scenario 500A of FIG. 5A is merely an example and such an example should not be construed as limiting the scope of disclosure.

FIG. 5B is a diagram that illustrates an exemplary scenario for set of data streams generation, in accordance with at least one embodiment described in the present disclosure. FIG. 5B is described in conjunction with elements from FIG. 1, FIG. 2, FIG. 3, FIG. 4, and FIG. 5A. With reference to FIG. 5B, there is shown an exemplary scenario 500B. The exemplary scenario 500B may include the hash de-selector 106A, a first hash function 506A, and a second hash function 506B, a first comparator 508A, a second comparator 508B, and the decoding logic 106C. A set of operations associated with the scenario 500B is described herein.

With reference to the scenario 500B, the hash de-selector 106A, the first comparator 508A, the second comparator 508B, and the decoding logic 106C may constitute the decoder system 106. As shown in FIG. 5B, a first block and a last block of the decoder system 106 may be the hash de-selector 106A and the decoding logic 106C, respectively. In between the hash de-selector 106A and the decoding logic 106C, “N” number of parallel paths may exist. The hash de-selector 106A may map equations associated with combinations of data streams to parallel paths. Each parallel path may capture one equation. For example, with reference to FIG. 5B, two parallel paths may exist. The encoded data stream of FIG. 5A may be provided as an input to the hash de-selector 106A. The hash de-selector 106A may select the first hash function 506A and the second hash function 506B. The first hash function 506A may be applied to the encoded data stream to generate the first hash output. The second hash function 506B may be applied to the encoded data stream to generate the second hash output. The output of the first hash function 506A and the second hash function 506B may be provided as an input to the decoding logic 106C. The decoding logic 106C may ensure that each and every equation is satisfied. Further, the decoding logic 106C may generate the set of data streams (for example, the set of data streams 114A).

It should be noted that the scenario 500B of FIG. 5B is merely an example and such an example should not be construed as limiting the scope of disclosure.

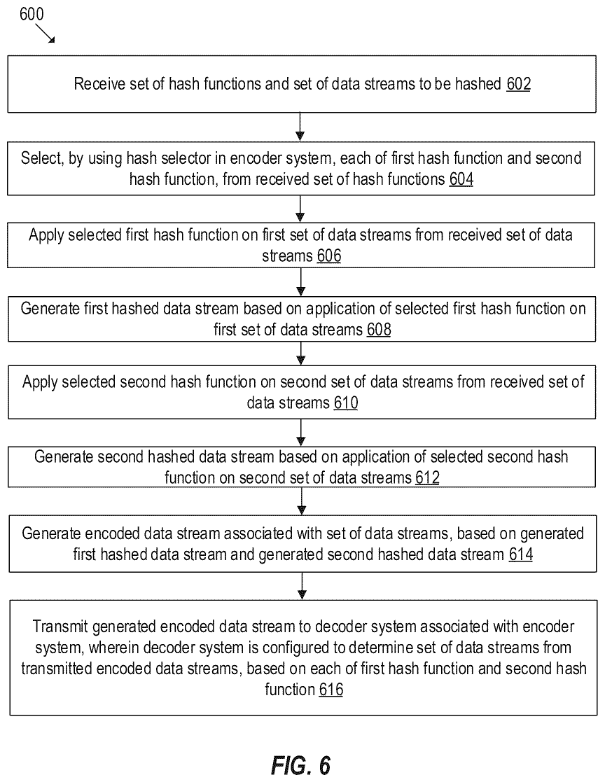

FIG. 6 is a diagram that illustrates a flowchart of an example method for bandwidth efficient hash code generation, in accordance with an embodiment of the disclosure. FIG. 6 is described in conjunction with elements from FIG. 1, FIG. 2, FIG. 3, FIG. 4, FIG. 5A, and FIG. 5B. With reference to FIG. 6, there is shown a flowchart 600. The method illustrated in the flowchart 600 may start at 602 and may be performed by any suitable system, apparatus, or device, such as, by the example electronic device 102 of FIG. 1, or the processor 204 of FIG. 2. Although illustrated with discrete blocks, the steps and operations associated with one or more of the blocks of the flowchart 600 may be divided into additional blocks, combined into fewer blocks, or eliminated, depending on the particular implementation.

At 602, the set of hash functions 116 and the set of data streams 114 to be hashed may be received. In an embodiment, the processor 204 may be configured to receive the set of hash functions 116 and the set of data streams 114 to be hashed. Details related to the reception of the set of hash functions 116 and the set of data streams 114 are further provided, for example, in FIG. 3 (at 302).

At 604, each of the first hash function 304A and the second hash function 304B may be selected from the received set of hash functions 116 by using the hash selector 104A. In an embodiment, the processor 204 may be configured to select, by using the hash selector 104A in the encoder system 104, each of the first hash function 304A and the second hash function 304B, from the received set of hash functions 116. Details related to the selection of the first hash function 304A and the second hash function 304B are further provided, for example, in FIG. 3 (at 304).

At 606, the selected first hash function 304A may be applied on the first set of data streams 306A from the received set of data streams 114. In an embodiment, the processor 204 may be configured to apply the selected first hash function 304A on the first set of data streams 306A from the received set of data streams 114. Details related to the application of the first hash function 304A is further provided, for example, in FIG. 3 (at 306).

At 608, the first hashed data stream 308A may be generated based on the application of the selected first hash function 304A on the first set of data streams 306A. In an embodiment, the processor 204 may be configured to generate the first hashed data stream 308A based on the application of the selected first hash function 304A on the first set of data streams 306A. Details related to the generation of the first hashed data stream 308A is further provided, for example, in FIG. 3 (at 308).

At 610, the selected second hash function 304B may be applied on the second set of data streams 310A from the received set of data streams 114. In an embodiment, the processor 204 may be configured to apply the selected second hash function 304B on the second set of data streams 310A from the received set of data streams 114. Details related to the application of the selected second hash function 304B is further provided, for example, in FIG. 3 (at 310).

At 612, the second hashed data stream 312A may be generated based on the application of the selected second hash function 304B on the second set of data streams 310A. In an embodiment, the processor 204 may be configured to generate the second hashed data stream 312A based on the application of the selected second hash function 304B on the second set of data streams 310A. Details related to the generation of the second hashed data stream 312A is further provided, for example, in FIG. 3 (at 312).

At 614, the encoded data stream 314A associated with the set of data streams 114 may be generated based on the generated first hashed data stream 308A and the generated second hashed data stream 312A In an embodiment, the processor 204 may be configured to generate the encoded data stream 314A associated with the set of data streams 114, based on the generated first hashed data stream 308A and the generated second hashed data stream 312A. Details related to the generation of the encoded data stream 314A is further provided, for example, in FIG. 3 (at 314).

At 616, the generated encoded data stream 314A may be transmitted to the decoder system 106 associated with the encoder system 104, wherein the decoder system 106 may be configured to determine the set of data streams 114 from the transmitted encoded data streams 314A, based on each of the first hash function 304A and the second hash function 304B. In an embodiment, the processor 204 may be configured to transmit the generated encoded data stream 314A to the decoder system 106 associated with the encoder system 104, wherein the decoder system 106 may be configured to determine the set of data streams 114 from the transmitted encoded data streams 314A, based on each of the first hash function 304A and the second hash function 304B. Details related to the transmission of the encoded data stream 314A is further provided, for example, in FIG. 3 (at 316). Control may pass to end.

Although the flowchart 600 is illustrated as discrete operations, such as 602, 604, 606, 608, 610, 612, 614, and 616. However, in certain embodiments, such discrete operations may be further divided into additional operations, combined into fewer operations, or eliminated, depending on the particular implementation without detracting from the essence of the disclosed embodiments.

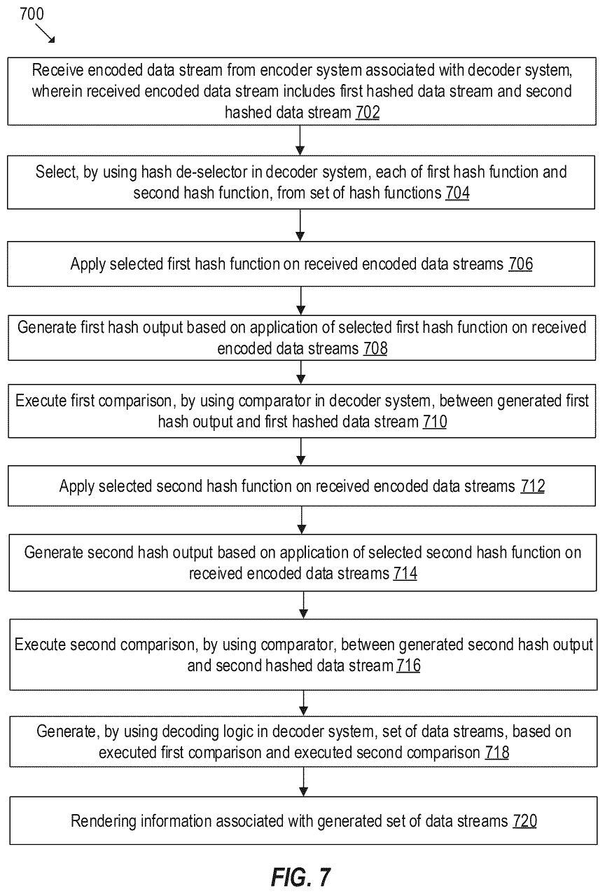

FIG. 7 is a diagram that illustrates a flowchart of an example method for generation of the set of data streams, in accordance with an embodiment of the disclosure. FIG. 7 is described in conjunction with elements from FIG. 1, FIG. 2, FIG. 3, FIG. 4, FIG. 5A, FIG. 5B, and FIG. 6. With reference to FIG. 7, there is shown a flowchart 700. The method illustrated in the flowchart 700 may start at 702 and may be performed by any suitable system, apparatus, or device, such as, by the example electronic device 102 of FIG. 1, or the processor 204 of FIG. 2. Although illustrated with discrete blocks, the steps and operations associated with one or more of the blocks of the flowchart 700 may be divided into additional blocks, combined into fewer blocks, or eliminated, depending on the particular implementation.

At 702, the encoded data stream 402A may be received from the encoder system 104 associated with the decoder system 106, wherein the received encoded data stream 402A may include the first hashed data stream (for example, the first hashed data stream 308A) and the second hashed data stream (for example, the second hashed data stream 312A. In an embodiment, the processor 204 may be configured to receive the encoded data stream 402A from the encoder system 104 associated with the decoder system 106, wherein the received encoded data stream 402A may include the first hashed data stream (for example, the first hashed data stream 308A) and the second hashed data stream (for example, the second hashed data stream 312A. Details related to the reception of the encoded data stream 402A is further provided, for example, in FIG. 4 (at 402).

At 704, each of the first hash function 406A and the second hash function 412A may be selected from the set of hash functions 116 by using the hash de-selector 106A in the decoder system 106. In an embodiment, the processor 204 may be configured to select, by using the hash de-selector 106A in the decoder system 106, each of the first hash function 406A and the second hash function 412A, from the set of hash functions 116. Details related to the selection of the first hash function 406A and the second hash function 412A are further provided, for example, in FIG. 4 (at 404).

At 706, the selected first hash function 406A may be applied on the received encoded data streams 402A. In an embodiment, the processor 204 may be configured to apply the selected first hash function 406A on the received encoded data streams 402A. Details related to the application of the first hash function 406A is further provided, for example, in FIG. 4 (at 406).

At 708, the first hash output 408A may be generated based on the application of the selected first hash function 406A on the received encoded data streams 402. In an embodiment, the processor 204 may be configured to generate the first hash output 408A based on the application of the selected first hash function 406A on the received encoded data streams 402. Details related to the generation of the first hash output 408A is further provided, for example, in FIG. 4 (at 408).

At 710, the first comparison may be executed between the generated first hash output 408A and the first hashed data stream 308A by using the comparator 106B in the decoder system 106. In an embodiment, the processor 204 may be configured to execute the first comparison, by using the comparator 106B in the decoder system 106, between the generated first hash output 408A and the first hashed data stream 308A. Details related to the execution of the first comparison is further provided, for example, in FIG. 4 (at 410).

At 712, the selected second hash function 412A may be applied on the received encoded data streams 402A. In an embodiment, the processor 204 may be configured to apply the selected second hash function 412A on the received encoded data streams 402A. Details related to the application of the selected second hash function 412A is further provided, for example, in FIG. 4 (at 412).

At 714, the second hash output 414A may be generated based on the application of the selected second hash function 412A on the received encoded data streams 402A. In an embodiment, the processor 204 may be configured to generate the second hash output 414A based on the application of the selected second hash function 412A on the received encoded data streams 402A. Details related to the generation of the second hash output 414A is further provided, for example, in FIG. 4 (at 414).

At 716, the second comparison between the generated second hash output 414A and the second hashed data stream 312A may be executed by using the comparator 106B. In an embodiment, the processor 204 may be configured to execute the second comparison, by using the comparator 106B, between the generated second hash output 414A and the second hashed data stream 312A. Details related to the execution of the second comparison is further provided, for example, in FIG. 4 (at 416).

At 718, the set of data streams (for example, the set of data streams 114) may be generated by using the decoding logic 106C in the decoder system 106 based on the executed first comparison and the executed second comparison. In an embodiment, the processor 204 may be configured to generate, by using the decoding logic 106C in the decoder system 106, the set of data streams (for example, the set of data streams 114), based on the executed first comparison and the executed second comparison; and Details related to the generation of the set of data streams is further provided, for example, in FIG. 4 (at 418).

At 720, the information associated with the generated set of data streams (for example, the set of data streams 114) may be rendered. In an embodiment, the processor 204 may be configured to render information associated with the generated set of data streams (for example, the set of data streams 114). Details related to the rendering of the information is further provided, for example, in FIG. 4 (at 420). Control may pass to end.

Although the flowchart 700 is illustrated as discrete operations, such as 702, 704, 706, 708, 710, 712, 714, 716, 718, and 720. However, in certain embodiments, such discrete operations may be further divided into additional operations, combined into fewer operations, or eliminated, depending on the particular implementation without detracting from the essence of the disclosed embodiments.

Various embodiments of the disclosure may provide one or more non-transitory computer-readable storage media configured to store instructions that, in response to being executed, cause a system (such as, the example electronic device 102 or the encoder system 104) to perform operations. The operations may include receiving a set of hash functions (for example, the set of hash functions 116) and a set of data streams (for example, the set of data streams 114) to be hashed. The operations may include selecting, by using a hash selector (for example, the hash selector 104A) in the encoder system 104, each of a first hash function (for example, the first hash function 34A) and a second hash function (for example, second hash function 304B), from the received set of hash functions 116. The operations may include applying the selected first hash function 304A on a first set of data streams (for example, the first set of data streams 306A) from the received set of data streams 114. The operations may further include generating a first hashed data stream (for example, the first hashed data stream 308A) based on the application of the selected first hash function 304A on the first set of data streams 306A. The operations may further include applying the selected second hash function 304B on a second set of data streams (for example, the second set of data streams 310A) from the received set of data streams 114. The operations may further include generating a second hashed data stream (for example, the second hashed data stream 312A) based on the application of the selected second hash function 204B on the second set of data streams 310A. The operations may further include generating an encoded data stream (for example, the encoded data stream 314A) associated with the set of data streams 114, based on the generated first hashed data stream 308A and the generated second hashed data stream 312A. The operations may further include transmitting the generated encoded data stream 314A to a decoder system (for example, the decoder system 106) associated with the encoder system 104, wherein the decoder system 106 may be configured to determine the set of data streams 114 from the transmitted encoded data streams 114, based on each of the first hash function 304A and the second hash function 304B.

Various embodiments of the disclosure may provide one or more non-transitory computer-readable storage media configured to store instructions that, in response to being executed, cause a system (such as, the example electronic device 102 or the decoder system 106) to perform operations. The operations may include receiving an encoded data stream (for example, the encoded data stream 402A) from the encoder system 104 associated with the decoder system 106, wherein the received encoded data stream 402A may include a first hashed data stream (for example, the first hashed data stream 308A) and a second hashed data stream (for example, the second hashed data stream 312A). The operations may include selecting, by using a hash de-selector (for example, the hash de-selector 106A) in the decoder system 106, each of a first hash function (for example, the first hash function 406A) and a second hash function (for example, the second hash function 412A), from the set of hash functions 116. The operations may further include applying the selected first hash function 406A on the received encoded data streams 402A. The operations may further include generating a first hash output (for example, the first hash output 408A) based on the application of the selected first hash function 406A on the received encoded data streams 402A. The operations may further include executing a first comparison, by using a comparator (for example, the comparator 106B) in the decoder system 106, between the generated first hash output 408A and the first hashed data stream 308A. The operations may further include applying the selected second hash function 412A on the received encoded data streams 402A. The operations may further include generating a second hash output (for example, the second hash output 414A) based on the application of the selected second hash function 412A on the received encoded data streams 402A. The operations may further include executing a second comparison, by using the comparator 106B, between the generated second hash output 414A and the second hashed data stream 312A. The operations may further include generating, by using a decoding logic (for example, the decoding logic 106C) in the decoder system 106, a set of data streams (for example, the set of data streams 114), based on the executed first comparison and the executed second comparison. The operations may further include rendering information associated with the generated set of data streams (for example, the set of data streams 114).

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, executed by a processor in an encoder system, comprising:
receiving a set of hash functions and a set of data streams to be hashed;
selecting, by using a hash selector in the encoder system, each of a first hash function and a second hash function, from the received set of hash functions;
applying the selected first hash function on a first set of data streams from the received set of data streams;
generating a first hashed data stream based on the application of the selected first hash function on the first set of data streams;
applying the selected second hash function on a second set of data streams from the received set of data streams;
generating a second hashed data stream based on the application of the selected second hash function on the second set of data streams;
generating an encoded data stream associated with the set of data streams, based on the generated first hashed data stream and the generated second hashed data stream; and
transmitting the generated encoded data stream to a decoder system associated with the encoder system, wherein
the decoder system is configured to determine the set of data streams from the transmitted encoded data streams, based on each of the first hash function and the second hash function.

2. The method according to claim 1, further comprising:
concatenating, by a concatenator in the encoder system, a first plurality of data streams from the received set of data streams, wherein
the first set of data streams is generated based on the concatenation of the first plurality of data streams; and
concatenating, by the concatenator, a second plurality of data streams from the received set of data streams, wherein
the second set of data streams is generated based on the concatenation of the second plurality of data streams.

3. The method according to claim 1, further comprising:
multiplexing, by a multiplexer in the encoder system, the first hashed data stream and the second hashed data stream, wherein
the generation of the encoded data stream is further based on the multiplexing of the first hashed data stream and the second hashed data stream.

4. The method according to claim 1, wherein each of the received set of data streams is represented in the generated encoded data stream.

5. The method according to claim 1, wherein the application of the first hash function and the application of the second hash function are performed in parallel.

6. The method according to claim 1, wherein the received set of hash functions corresponds to at least one of a message-digest 5 (MD-5) hash function, a secure hash algorithm 256 (SHA-256) function, a secure hash algorithm 3 (SHA-3) function, or a BLAKE-2 hash function.

7. The method according to claim 1, wherein the received set of data streams corresponds to at least one of a text file, an audio file, a video file, an image file, or media content.

8. The method according to claim 1, further comprising:
transmitting, the received set of hash functions to the decoder system based on the transmission of the generated encoded data stream, wherein
the determination of the set of data streams by the decoder system is further based on the transmission of the set of hash functions.

9. A method, executed by a processor in a decoder system, comprising:
receiving an encoded data stream from an encoder system associated with the decoder system, wherein
the received encoded data stream includes a first hashed data stream and a second hashed data stream;
selecting, by using a hash de-selector in the decoder system, each of a first hash function and a second hash function, from a set of hash functions;
applying the selected first hash function on the received encoded data streams;
generating a first hash output based on the application of the selected first hash function on the received encoded data streams;
executing a first comparison, by using a comparator in the decoder system, between the generated first hash output and the first hashed data stream;
applying the selected second hash function on the received encoded data streams;
generating a second hash output based on the application of the selected second hash function on the received encoded data streams;
executing a second comparison, by using the comparator, between the generated second hash output and the second hashed data stream; and
generating, by using a decoding logic in the decoder system, a set of data streams, based on the executed first comparison and the executed second comparison; and
rendering information associated with the generated set of data streams.

10. The method according to claim 9, wherein the encoder system is configured to generate the encoded data stream based on the first hash function and the second hash function.

11. The method according to claim 9, wherein
the first hash data stream corresponds to a concatenation of a first plurality of data streams from the generated set of data streams; and
the second hash data stream corresponds to a concatenation of a second plurality of data streams from the generated set of data streams.

12. The method according to claim 9, wherein each of the first hashed data stream and the second hashed data stream is multiplexed in the received encoded data stream.

13. The method according to claim 9, wherein the application of the first hash function and the application of the second hash function are performed in parallel.

14. The method according to claim 9, wherein the generated set of data streams corresponds to at least one of a text file, an audio file, a video file, an image file, or media content.

15. The method according to claim 9, further comprising receiving, the set of hash functions from the encoder system, based on the reception of the encoded data stream.

16. The method according to claim 9, wherein the encoder system is configured to:
receiving the set of hash functions and the set of data streams to be hashed;
selecting, by using a hash selector in the encoder system, each of the first hash function and the second hash function, from the received set of hash functions;
applying the selected first hash function on a first set of data streams from the received set of data streams;
generating the first hashed data stream based on the application of the selected first hash function on the first set of data streams;
applying the selected second hash function on a second set of data streams from the received set of data streams;
generating the second hashed data stream based on the application of the selected second hash function on the second set of data streams;
generating the encoded data stream associated with the set of data streams, based on the generated first hashed data stream and the generated second hashed data stream; and
transmitting the generated encoded data stream to the decoder system associated with the encoder system.

17. One or more non-transitory computer-readable storage media configured to store instructions that, in response to being executed, cause an electronic device associated with an encoder system to perform operations, the operations comprising:
receiving a set of hash functions and a set of data streams to be hashed;
selecting, by using a hash selector in the encoder system, each of a first hash function and a second hash function, from the received set of hash functions;
applying the selected first hash function on a first set of data streams from the received set of data streams;
generating a first hashed data stream based on the application of the selected first hash function on the first set of data streams;
applying the selected second hash function on a second set of data streams from the received set of data streams;
generating a second hashed data stream based on the application of the selected second hash function on the second set of data streams;
generating an encoded data stream associated with the set of data streams, based on the generated first hashed data stream and the generated second hashed data stream; and
transmitting the generated encoded data stream to a decoder system associated with the encoder system, wherein
the decoder system is configured to determine the set of data streams from the transmitted encoded data streams, based on each of the first hash function and the second hash function.

18. The one or more non-transitory computer-readable storage media according to claim 17, the operations further comprising:
concatenating, by a concatenator in the encoder system, a first plurality of data streams from the received set of data streams, wherein
the first set of data streams is generated based on the concatenation of the first plurality of data streams; and
concatenating, by the concatenator, a second plurality of data streams from the received set of data streams, wherein
the second set of data streams is generated based on the concatenation of the second plurality of data streams.

19. The one or more non-transitory computer-readable storage media according to claim 17, the operations further comprising:
multiplexing, by a multiplexer in the encoder system, the first hashed data stream and the second hashed data stream, wherein
the generation of the encoded data stream is further based on the multiplexing of the first hashed data stream and the second hashed data stream.

20. The one or more non-transitory computer-readable storage media according to claim 17, the operations further comprising:
transmitting, the received set of hash functions to the decoder system based on the transmission of the generated encoded data stream, wherein
the determination of the set of data streams by the decoder system is further based on the transmission of the set of hash functions.
